(19) United States
(12) Patent Application Publication
(10) Pub. No.: US 2007/0253585 A1
(43) Pub. Date: Nov. 1, 2007

(54) Time-adaptive adjustment of a hearing aid apparatus and corresponding method

(75) Inventor: Andre Steinbuss, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/789,930

(22) Filed: Apr. 26, 2007

(30) Foreign Application Priority Data
Apr. 27, 2006 (DE) 10 2006 019 728.3

(51) Int. Cl. H04R 25/00

(52) U.S. Cl. 381/312; 381/315; 381/316

(57) ABSTRACT

The spontaneous acceptance of a hearing system is to be improved. To this end, a hearing aid apparatus and a corresponding method for adjusting the hearing aid apparatus are provided, with a part of an input signal spectrum first being amplified with a first frequency. This part of the input signal spectrum, which is to be amplified, is now automatically shifted from the first frequency to a second frequency as a function of the time. This allows a time-adaptive parameterization of the compression ratio. This in turn results in an increased spontaneous acceptance and in an acclimatization process to new frequency samples on the part of the hearing-impaired person being assisted.

### CROSS REFERENCE TO RELATED APPLICATIONS

This application claims priority of German application No. 10 2006 019 728.3 filed Apr. 27, 2006, which is incorporated by reference herein in its entirety.

### FIELD OF THE INVENTION

The present invention relates to a method for adjusting a hearing aid apparatus by amplifying a part of an input signal spectrum with a specific frequency.

### BACKGROUND OF THE INVENTION

A high potential is awarded to the approach of the frequency compression, the so-called frequency transposition, which maps the high frequencies in the lower frequency range, in particular for profound hearing losses or the initial care in the case of children. Algorithms of this type are already implemented in some hearing devices which are found on the market.

Since the known sound characteristics are however frequently significantly distorted by the frequency compression, such therapeutic approaches with hearing aids are frequently rejected or require a high level of aftercare from the responsible audiologist or hearing device acoustician. In this case, the level of the frequency transposition is successively increased in the individual sessions, until a defined final value is reached.

In each individual session, the audiologist and respectively the hearing device acoustician must reparameterize the algorithms used within the framework of the hearing device coverage. This also demonstrates a non-user-friendly procedure for the patient.

The publications DE 195 42 961 C1, DE 100 21 985 A1 and EP 1 363 473 A2 disclose hearing devices in each instance with temporally controlled adaptation. In this context, the parameters overall volume, volume in the individual frequency ranges, dynamics of the amplification, frequency path and intensity of the interference noise elimination are temporally modified.

The publication DE 42 17 629 A 1 furthermore discloses a hearing device having a means for the electronic adjustment of at least one transmission parameter in the signal path. To improve the recognizability of the transmission parameter selected in each instance, a preferably acoustic signal is emitted, which is characteristic for each electronically adjusted transmission parameter. The volume is mentioned as a transmission parameter.

### SUMMARY OF THE INVENTION

The object of the present invention thus consists in configuring the adjustment of a hearing aid apparatus, and respectively the hearing device adjustment, in a more user-friendly manner for the patient.

In accordance with the invention, this object is achieved by a method for adjusting a hearing aid apparatus, by amplifying a part of an input signal spectrum with a first frequency and automatically shifting the part of the input signal spectrum, which is to be amplified, from the first frequency to a second frequency as a function of the time.

Furthermore, a hearing aid apparatus is provided in accordance with the invention, having an amplification facility for amplifying a part of an input signal spectrum with a first frequency and a time control facility for controlling the amplification facility such that the part of the input spectrum, which is to be amplified, is automatically shifted from the first frequency to a second frequency as a function of the time.

The inventive temporally adaptive readjustment of the intensity of the frequency transposition results in two advantages. On the one hand, a high spontaneous acceptance of the audio system can be reached by means of sound characteristics of the audio system which is almost undistorted between two adaptation steps. On the other hand, the hearing-impaired person can however be assisted in respect of the learning and acclimatization process to the new frequency pattern.

At least one part of the input signal spectrum is preferably automatically progressively compressed as a function of the time. This enables a new frequency compression, within the framework of a hearing device adjustment for instance, to be carried out in a user-friendly manner in short time intervals.

With the shift of a part of the input signal spectrum, the amplification value can remain untouched by the frequency shift for this part of the input signal spectrum. This means that the amplification after the frequency shift is the same as before. Frequency ratios of spectral parts can thus also be retained after the frequency shift.

The shift can furthermore be carried out in a number of time steps up to a predetermined final value. In this context, the time steps and thus also the shift steps can be selected to be so small that the user is hardly able to perceive them and a virtually continuous shift takes place.

The shift of the part of the input signal spectrum advantageously takes place band by band. It is thus not necessary for the entire spectrum to be compressed at one time instant, but individual bands can instead be shifted consecutively so that they attract the user's attention less.

### BRIEF DESCRIPTION OF THE DRAWINGS

The present invention is now described in more detail below with reference to the appended drawings, in which;

FIG. 1 shows an amplification curve for a number of frequency bands;

FIG. 2 shows the amplification curve in FIG. 1 according to a first compression step and

FIG. 3 shows the amplification curve in FIG. 1 according to a second compression step

### DETAILED DESCRIPTION OF THE INVENTION

The exemplary embodiments illustrated in more detail below represent preferred embodiments of the present invention.

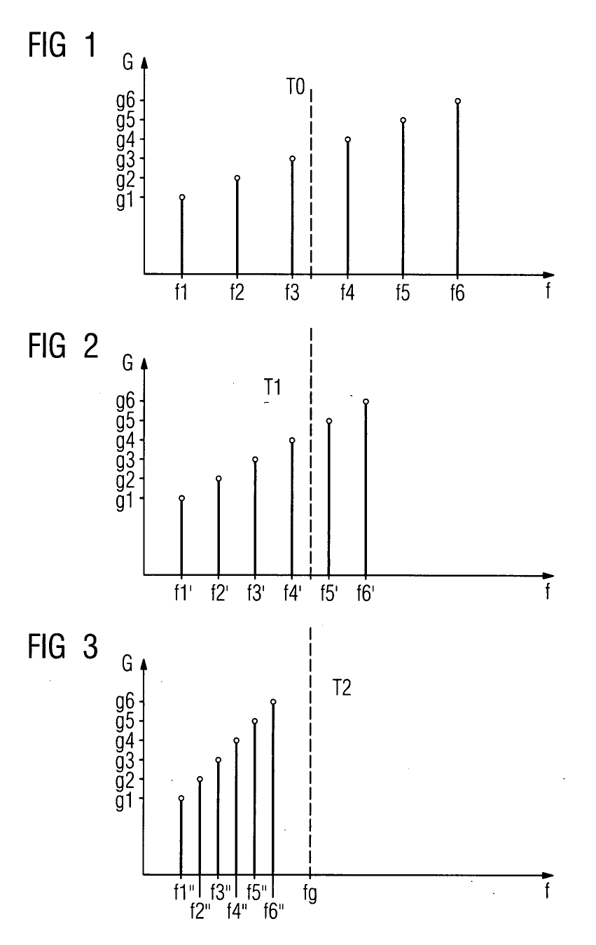

FIG. 1 shows an amplification curve for different frequencies f1 to f6. Each of these frequencies f1 to f6 can also represent a frequency band. Furthermore, an amplification value g1 to g6 is assigned to each of these frequencies and/or each of these frequency bands. To simplify matters, the amplification increases in a linear fashion with the frequency.

The amplification curve in FIG. 1 is implemented in the audio system at time instant T0.

Since the patient is now only able to perceive sound below the limit frequency fg, he/she will not be able to hear high-frequency parts f4, f5 and f6. A frequency compression is carried out for this reason, as a result of which all spectral parts are shifted below the hearing limit fg.

As, prior to use of the hearing apparatus, the patient is only accustomed to hearing the frequencies f1 to f3, it is favorable, in respect of the acceptance, to only present him/her initially with these frequencies in amplified form, even with the hearing device. This initial adaptation takes place with the audiologist or hearing device acoustician at time instant T0. In accordance with the invention, a temporal adaptation is to be carried out in respect of a frequency transposition and/or frequency compression. The aim here is to map all frequencies and/or frequency bands f1 to f6 in the range below fg.

The compression is automatically carried out in a number of time steps. A first compression step takes place at time instant T1. The amplification curve resulting therefrom is indicated in FIG. 2. The frequency f1 is thus mapped onto the frequency f1′, the frequency f2 onto the frequency f2′ and so forth. The frequencies are thus shifted into the audible range according to a selectable specification. The amplification value g1 to g6 is retained for each frequency

From time instant T1, the patient is now able to perceive locations, tones and noises, which originally lay outside his/her hearing range. By way of example, he/she receives the sound, which is actually present with the frequency f4, now shown with the frequency f4′, which he/she hears because it lies below the limit frequency fg.

In a second compression step, all frequencies f1 to f6 are now mapped in the range below the limit frequency fg so that the frequencies f1″ to f6″ result. The patient now also receives the high-frequency acoustic portions with f5 and f6 in its audio range below the limit frequency fg. He/she is thus able to perceive all acoustic portions, even when compressed.

In accordance with the invention, a temporally adaptive control of the frequency transposition takes place, the intensity of which increases successively with the wearing time of the hearing device. The temporally slow adaptation assists with the training on the modified acoustic pattern.

A frequency transposition takes place exclusively in the example chosen in FIG. 1 to FIG. 3. The amplification values g1 to g6 are retained. It can however also be favorable in some circumstances to carry out a temporal amplification adaptation at the same time as the frequency transposition. In this context, the individual amplification values g 1 to g6 would then also change.

Furthermore, it is also advantageous to shift the individual frequency bands among one another in a non-linear fashion. The distance between the frequencies f1″ and f2″ could herewith be greater for instance than the distance between the frequencies f5″ and f6″. This means that the higher frequency portion in the audible range would be more densely packed below the limit frequency fg than the lower frequencies. Furthermore, any other non-linear shift in the audible frequency range is also conceivable.

The individual frequency bands can also be shifted into the desired range irrespective of one another. It can be favorable for instance to initially retain the frequency bands f1 to f3 and only to shift the frequency band f5 into the audible range. In a further shift step, the further initially non-audible frequency bands can then be shifted into the audible range. The shift of the frequency bands in the audible range can be carried out as a separate step.

The steps illustrated above allow different types of frequency transpositions to be reached, all of which lead however to an increase in the acceptance of an audio system and assist with the acclimatization processes.

1.-10. (canceled)

11. A method for adjusting a hearing aid apparatus, comprising:
amplifying a portion of an input signal spectrum with a first frequency; and
automatically shifting the portion of the input signal spectrum from the first frequency to a second frequency as a function of time.

12. The method as claimed in claim 11, wherein at least one part of the input signal spectrum comprising the portion of the input signal spectrum is automatically compressed as the function of time.

13. The method as claimed in claim 11, wherein an amplification value of the portion of the input signal spectrum remains unchanged or is changed after the shifting.

14. The method as claimed in claim 11, wherein the shifting is carried out in several time steps until reaching a predetermined final value.

15. The method as claimed in claim 11, wherein the portion of the input signal spectrum is shifted band by band.

16. The method as claimed in claim 11, wherein the portion of the input signal spectrum is shifted linearly.

17. The method as claimed in claim 11, wherein the portion of the input signal spectrum is shifted non-linearly.

18. The method as claimed in claim 17, wherein a higher frequency portion in an audible frequency range of a user of the hearing aid apparatus is more densely packed than a lower frequency portion.

19. The method as claimed in claim 11, wherein the first frequency is above an audible frequency range of a user of the hearing aid apparatus and the second frequency is below the audible frequency range.

20. The method as claimed in claim 19, wherein the second frequency is in a desired frequency range of the user of the hearing aid apparatus.

21. A hearing aid apparatus, comprising:
an amplification unit that amplifies a portion of an input signal spectrum with a first frequency; and
a time control unit that controls the amplification unit such that the portion of the input signal spectrum is automatically shifted from the first frequency to a second frequency as a function of the time.

22. The hearing aid apparatus as claimed in claim 21, wherein at least one part of the input signal spectrum comprising the portion of the input signal spectrum is automatically compressed as the function of time.

23. The hearing aid apparatus as claimed in claim 21, wherein an amplification value of the portion of the input signal spectrum remains unchanged or is changed after the shifting.

24. The hearing aid apparatus as claimed in claim 21, wherein the shifting is carried out in several time steps until reaching a predetermined final value implemented in the time control unit.

25. The hearing aid apparatus as claimed in claim 21, wherein the portion of the input signal spectrum is shifted band by band.

26. The hearing aid apparatus as claimed in claim 21, wherein the portion of the input signal spectrum is shifted linearly.

27. The hearing aid apparatus as claimed in claim 21, wherein the portion of the input signal spectrum is shifted non-linearly.

28. The hearing aid apparatus as claimed in claim 27, wherein a higher frequency portion in an audible frequency range of a user of the hearing aid apparatus is more densely packed than a lower frequency portion.

29. The hearing aid apparatus as claimed in claim 21, wherein the first frequency is above an audible frequency range of a user of the hearing aid apparatus and the second frequency is below the audible frequency range.

30. The hearing aid apparatus as claimed in claim 29, wherein the second frequency is in a desired frequency range of the user of the hearing aid apparatus.
